(19) United States
(12) Patent Application Publication
(10) Pub. No.: US 2012/0006294 A1
(43) Pub. Date: Jan. 12, 2012

(54) ISOLATED COOL AIR INTAKE

(76) Inventor: Sam Wolanyk, San Diego, CA (US)

(21) Appl. No.: 12/831,197

(22) Filed: Jul. 6, 2010

(51) Int. Cl. F02M 35/10; B23P 11/00

(52) U.S. Cl. 123/184.21; 29/428

(57) ABSTRACT

A cool air intake and related methods are disclosed for providing cool air to a combustion chamber input of an engine. The cool air intake includes a thermally insulated length of tubing for minimizing heat dissipation from intake components to the intake airstream. The thermally insulated length of tubing minimizes input air heating due to engine compartment heat transfer by intake components. Cool air provided by the disclosed intake systems provide increased fuel efficiency and increased engine performance.

### FIELD OF THE INVENTION

This invention relates to automotive engine combustion systems, and more particularly to an improved air intake system for obtaining cool air from engine surroundings for improved combustion and performance characteristics.

### BACKGROUND OF THE INVENTION

It has been well established that efficiency of a thermodynamic system, such as a combustion engine system, increases proportionally with respect to input and output temperatures. Performance of internal combustion engines can be improved therefore by providing cool air into the combustion chamber of the engine.

Further known in the art is the effect of engine heat radiated from the combustion block as it becomes dissipated into the surrounding air and under an enclosed hood of an automobile. Heat formed under the hood is widely known to transfer among other local components, heating surrounding components to an increased temperature.

Air intake systems are components designed to access and direct cool air from a point distal to the engine block to an engine combustion chamber, or piston. Cool air is desired for improved efficiency of the engine, therefore air located away from the engine block is ideal for use in the combustion chamber.

Modern air intake systems include a tubular member extending from the engine combustion input to a point distal from the engine block, where a filter is attached at the distal end for filtering cool air as it is accessed and directed into the engine combustion chamber. It is important to filter the air such that unwanted particulate is isolated and prevented from entering the combustion chamber or causing buildup which can reduce performance or harm engine components. Furthermore, it is important to filter the air without restricting the flow air into the combustion chamber because a reduction in oxygen will inevitably decrease engine performance.

Because heated air trapped under the hood of an automobile often disperses away from the engine block, it is not always enough to locate the air intake filter away from the heat source. US 2005/0217625, titled: “HEAT SHIELDED AIR INTAKE SYSTEM”, by Niaken et. Al., discloses a heat shield for surrounding an air intake filter such that heated air trapped under the hood, or engine compartment heat, is isolated from entry into the air intake, the entire contents of which are hereby incorporated by reference. By isolating engine compartment heat, the heat shield serves to improve engine performance allowing substantially only cool air to enter into the air intake system, thereby increasing performance as discussed above. One problem with the heat shielded system is that the air intake itself is not isolated from engine compartment heat and is therefore subject to increased temperature; and air traveling through the intake manifold is subject to dissipate that heat as it travels from the shielded intake filter to the engine combustion chamber input. Effectively, this system isolates engine compartment heat and prevents the heated air from entering the shielded filter, however, the length of tube for which the air travels is not isolated from engine compartment heat, and is therefore subject to heating. Accordingly, air traveling from the shielded intake filter to the combustion chamber input acts to dissipate heat from the air-flow tubing because the air-flow tubing itself is not isolated from the engine compartment heat. The shielded intake filter therefore fails to deliver cool air into the engine combustion chamber.

Most air-flow tubing used in engine manifolds is fabricated from aluminum or other cost-efficient metals, or plastic. It is well known that aluminum is an excellent thermal-conductor, therefore making the aluminum air-flow tubing of an air-intake system generally a poor choice. Anodized aluminum, although not electrically conductive, remains thermally conductive and capable of transferring or conducting engine compartment heat to input air from the air intake. Similarly, PVC and other plastics commonly used for engine air components can be thermally conductive, even if not as conductive as the aluminum air-flow tubing. For this reason, there is a need for an improved air-intake system which isolates and prevents engine compartment heat from entering the engine at the intake filter, and further prevents heat dissipation or transfer from intake components to the input cool-air supply. There is a need for an isolated air-intake system such that heat transfer from engine compartment heat to the input cool-air supply is reduced or eliminated. Furthermore, there is a need for a cost effective cool air intake system for providing improved fuel efficiency and engine performance characteristics.

### SUMMARY OF THE INVENTION

It is therefore an object of the invention to provide a system and method for reducing or substantially eliminating the transfer of engine compartment heat from air-flow tubing to input air-flow such that cool air is delivered to the engine combustion chamber for improved efficiency and performance.

In one embodiment, a cool air intake system is provided, the cool air intake includes a length of tubing having a proximal end and a distal end, the proximal end of the tubing is attached at a combustion chamber input, and the distal end of the tubing is attached to a filter. The length of tubing further includes a first inner-concentric tubing, a second outer-concentric tubing axially aligned and disposed concentric to the first inner-concentric tubing, and a cavity formed therebetween. The cavity can further include a thermal insulator such as vacuum, silica aerogel, or a circulating fluid.

In another embodiment, a valve is positioned on the second outer-concentric tubing and extends into said cavity. A pump can be attached to the valve for extracting air from the cavity to create a vacuum cavity.

In yet another embodiment, two valves are disposed on the second outer-concentric tubing and are recessed into said cavity. The valves can be connected to a pump for circulating a fluid through the cavity of the air intake. The circulated fluid can be a coolant for actively cooling the tubing, and therefore cooling air as it flows through the tubing and into the combustion input.

In another embodiment, an air filter is attached to a distal end of the first length of tubing, such that particulate is filtered from the air without restricting flow to the combustion input. The air filter can further include one or more shield members for isolating the air intake filter from engine compartment heat.

In another embodiment, the second outer-tubing is welded to the first inner-concentric tubing at opposing ends to form a cavity. Alternatively, a polymer or rubber gasket can be placed between the first and second tubes for hermetic sealing.

In another embodiment, an aerodynamic mesh can be incorporated into the first inner concentric tubing for guiding input air into the engine intake port, while cooling air as it propagates through the mesh. The mesh can be thermally conductive, such as aluminum mesh, and can include any mesh pattern known in the art, such as honeycomb, square mesh, circular mesh, triangular mesh, etc. In this embodiment, a coolant can be cycled between the inner and outer tubings, or coolant region, such that the mesh is adapted to absorb heat from input air and dissipate the heat to the cooled region. It is important to design the mesh portion for minimal resistance and turbulence with input air flow. Furthermore, the mesh portion can extend along a portion of the cool air intake, or up to the entire length of the cool air intake.

In another embodiment, the cool air intake includes at least one Hobbs Pressure Activated Switch and a coolant tank. The coolant tank can include a liquefied coolant and can be adapted to flow the coolant through a coolant region within the cool air intake. A user can activate the Hobbs Pressure Activated Switch (HPAS) upon a desire for increased horsepower, and upon activating the HPAS, a charge of liquefied coolant is released into a coolant region of the cool air intake, immediately cooling input air as it flows through the cool air intake toward the engine intake port. In this embodiment, a short burst of coolant flow can be optimized to cool the air intake for up to several minutes, during which time Horsepower can be increased up to 10%.

These and other embodiments will become apparent after further review of the enclosed drawings and the following detailed description of the invention.

### BRIEF DESCRIPTION OF THE DRAWINGS

These and other attributes of the invention are further described in the following detailed description, particularly when reviewed in conjunction with the drawings, wherein:

FIG. 1 illustrates a perspective view of a preferred embodiment of the invention wherein an air intake system includes a thermally insulated length of tubing.

FIG. 2 illustrates a rear view of the air intake system of FIG. 1, the air intake including a valve for adjusting the contents of the thermally insulated cavity.

FIG. 3 illustrates an alternative view of the air intake of FIGS. 1-2.

FIG. 4 illustrates a prior art air intake, the length of tubing is not thermally insulated and is therefore adapted to transfer heat from the engine compartment to the input air flow.

FIG. 5 illustrates a cavity formed between a first inner-concentric tube and a second outer-concentric tube; the cavity can include a vacuum cavity, a thermal insulator, or a circulating fluid.

FIG. 6 illustrates an air intake system according to one embodiment of the invention wherein two valves are disposed on the outer-concentric tube and extend recessed to the cavity; a pump can be attached to the two valves such that a fluid can circulated between the valves for cooling the length of tubing and therefore cooling the air-flow therein.

FIG. 7 is an alternative view of the air intake of FIG. 6.

FIG. 8 is a cross sectional view of a cool air intake according to one embodiment of the invention, the intake includes an outer concentric tubing, an inner concentric tubing, and a plurality of surface area fins disposed radially outward from the inner concentric tubing.

FIG. 9 is a perspective cross-sectional view of the air intake according to FIG. 8.

FIG. 10 illustrates a cool air intake according to an embodiment of the invention, wherein the outer concentric tubing is welded to the inner concentric tubing to form a sealed region.

FIG. 11 illustrates a cool air intake according to an embodiment of the invention, wherein the outer concentric tubing includes a flexible portion at each end, the flexible portion is coupled to the inner concentric tubing using a hose clamp or other attachment means.

FIG. 12 illustrates a cool air intake according to yet another embodiment of the invention, wherein an outer concentric tubing is connected to an inner concentric tubing using a flexible gasket or coupler, the coupler attached to the tubing using a hose clamp or other attachment means.

FIG. 13a illustrates a cross sectional view of a cool air intake according to one embodiment of the invention, the intake includes an outer concentric tubing, an inner concentric tubing, and a surface area mesh disposed within the inner concentric tubing.

FIG. 13b illustrates a cross sectional view of a cool air intake according to one embodiment of the invention, the intake includes an outer concentric tubing, an inner concentric tubing, a plurality of fins extending radially outward from the inner concentric tubing into the cooled region, and a surface area mesh disposed within the inner concentric tubing.

FIG. 13c illustrates a cross sectional view of a cool air intake according to one embodiment of the invention, the intake includes an outer concentric tubing, an inner concentric tubing, and a plurality of surface area fins disposed radially inward from the inner concentric tubing, the fins include small and large fins.

### DETAILED DESCRIPTION

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions without departing from the spirit and scope of the invention. Certain embodiments will be described below with reference to the drawings wherein illustrative features are denoted by reference numerals.

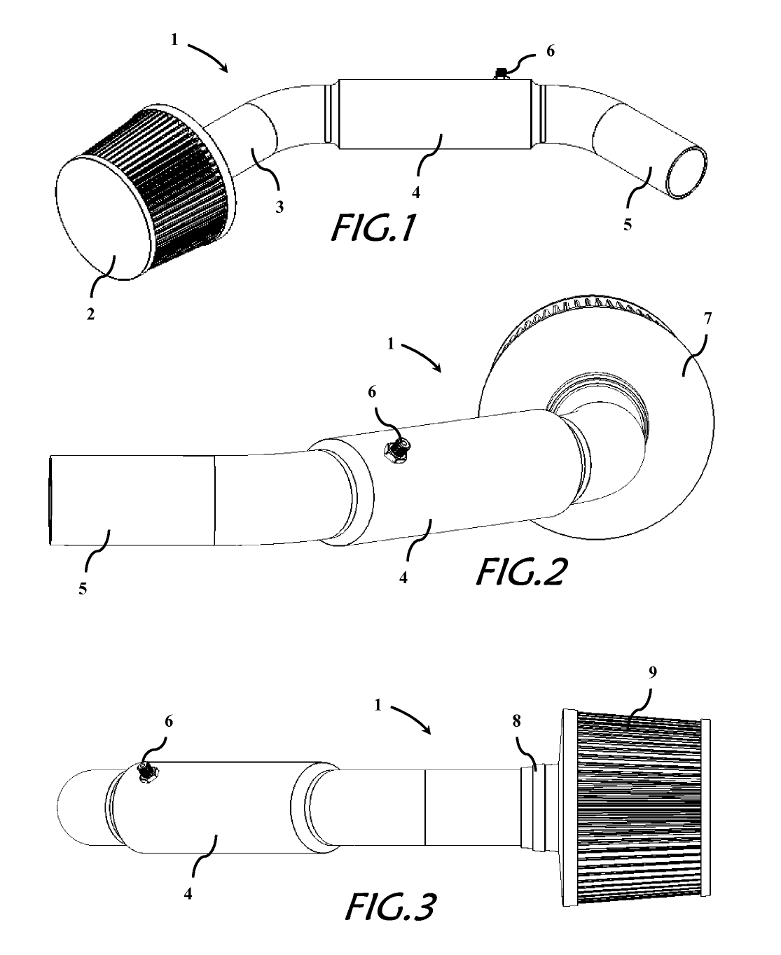

Now turning to FIG. 1, a preferred embodiment of a cool air intake is provided; the air intake includes a thermally insulated length of tubing for reducing heat transfer from the tube itself to the input air-flow. The cool air intake 1 includes a first inner-concentric length of tubing having a proximal end 5 and a distal end 3. A second outer-concentric length of tubing 4 is axially concentrically disposed at least partially along the first length of tubing such that a gap or cavity is formed between the first and second lengths of tubing. The second length of tubing is hermetically sealed to the first length of tubing at opposite ends. A valve 6 is disposed on the second outer-concentric length of tubing and is recessed to contact the inner sealed cavity. A filter 2 is attached to the first length of tubing at the distal end 3.

The first inner-concentric length of tubing includes a first diameter D₁. The second outer-concentric length of tubing includes a second diameter D₂, wherein D₂ is greater than D₁.

A pump can be attached to the valve 6, such that a user can remove air from the hermetically sealed cavity between the first and second lengths of tubing. A vacuum cavity creates a thermally-insulated section of tubing, such that heat transfer from the engine compartment to the input air flow is reduced by thermally insulating a large section of tubing, and therefore insulating the air flow within the section tubing from such heat transfer.

In one embodiment, the valve can be used to deliver a thermal insulator into the cavity region. An example of a thermal insulator includes a silage aerogel or similar material.

FIG. 2 illustrates a rear view of the air intake of FIG. 1. The base 7 of the air filter 2 is attached to the distal end 3 of the first inner-concentric tube. The second outer-concentric tube is axially concentrically disposed along a length of the first inner-concentric tube. The second outer-concentric tube further includes a valve disposed on an outer surface of the outer-concentric tube and extends inwardly into the cavity of the insulated tube section 4. The second outer-concentric tube is hermetically sealed to the first inner-concentric length of tubing at opposing ends to form a cavity therein. The hermetical seal at each end may include a welded seal joint, a polymer gasket, rubber gasket, or other hermetic seal.

FIG. 3 further illustrates the cool air intake of FIGS. 1-2, the air intake further including a filter having a plurality of circumferentially disposed folds for filtering particulate from the input air flow. It is important to filter particulate which could damage the engine while not restricting the flow of air to the input combustion chamber. Accordingly a filter should be balanced to filter enough particulate without restricting flow of oxygen to the engine.

As further illustrated in FIG. 3, the filter can be attached to the air flow tube at the distal end by a hose clamp 8, or other means. Furthermore, the air filter can further include one or more shield members for isolating the filter from the engine compartment and surrounding heated air, thereby accessing cool air from outside the engine compartment.

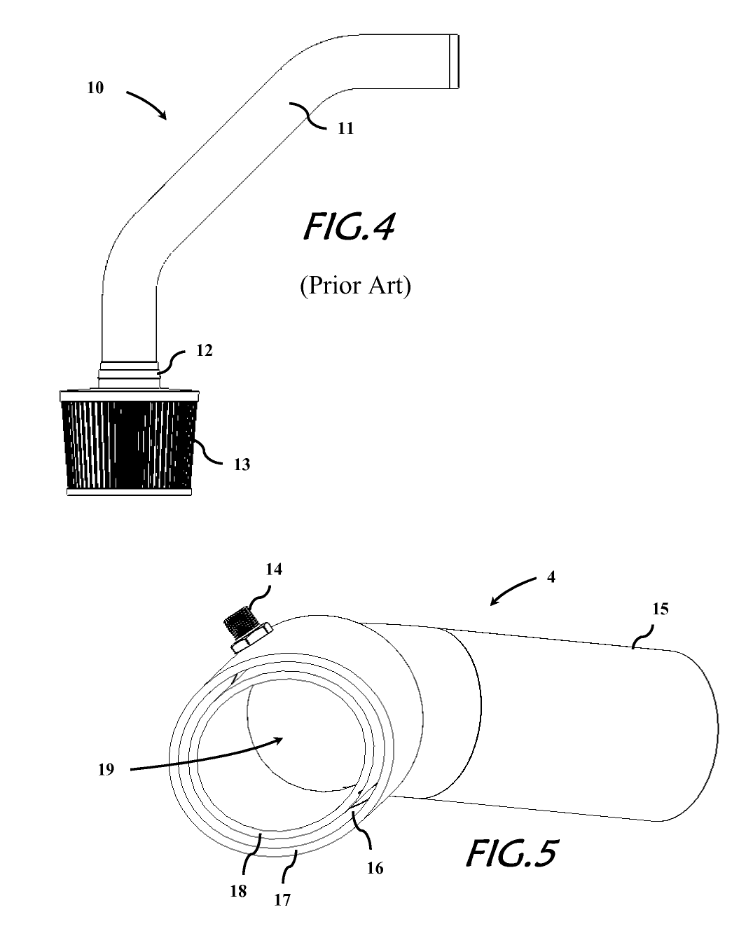

FIGS. 4-5 further illustrate certain improvements over prior art air intake systems, for example, FIG. 4 illustrates a prior art intake system having a length of tubing attached to a filter, such that the filter provides particulate-free air flow to the input combustion chamber. The length of tubing is not thermally insulated; in fact these air intakes are commonly fabricated from aluminum tubing. Using this prior art embodiment, engine compartment heat, or heat transferred from the engine block to surrounding air, is easily transferred to the aluminum tubing because aluminum is an excellent thermal conductor. Therefore, as air flows from the filter to the engine through the tubing, excess heat from the tubing is transferred to the input air flow. Accordingly, the prior art intake is not sufficiently a “cool air intake” as it fails to provide cool air to the engine combustion input.

In contrast to the prior art, FIG. 5 illustrates a cross section of the thermally insulated length of tubing according to one embodiment of the invention. As illustrated in FIG. 5, the thermally insulated length of tubing 4 includes an inner concentric length of tubing 18, an outer-concentric length of tubing 17, and a cavity disposed therebetween 16. Air flow is directed through a lumen 19 towards a proximal end 15 prior to entering the engine input. A valve 14 is used to configure the cavity space with vacuum, a thermal insulating material such as silica aerogel, or a circulating fluid.

As can be understood in view of FIG. 5 (above), the present invention includes an inner section of tubing which is thermally isolated from engine compartment heat. Accordingly, as air flows through the cool air intake of the present invention, the same air is not subject to heat transfer along the length of thermally insulated tubing.

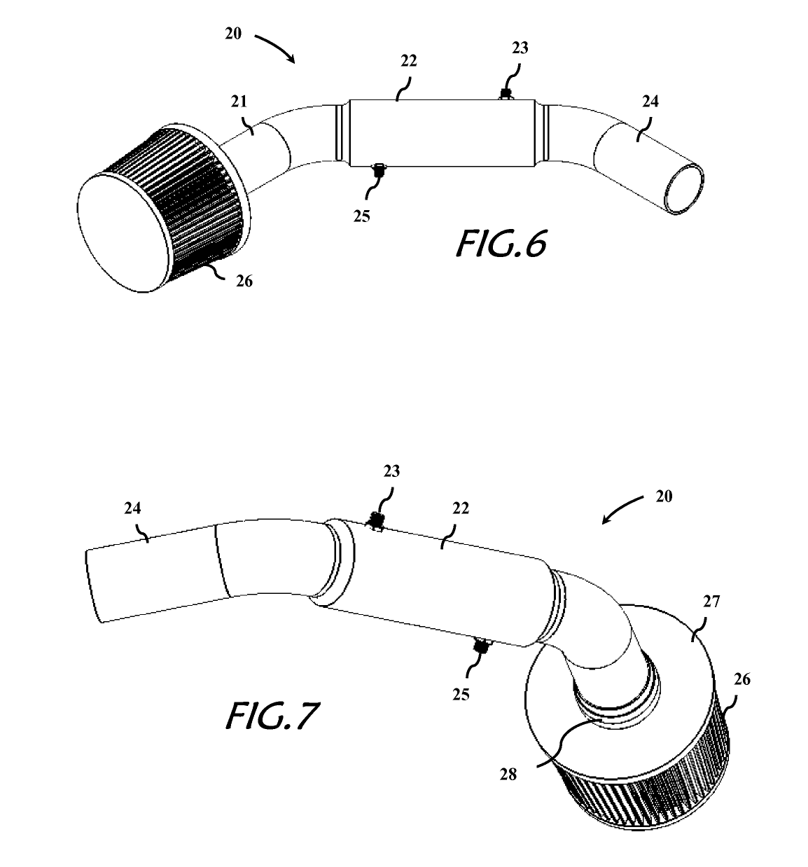

FIG. 6 illustrates an alternative embodiment of the invention where an air intake 20 includes two valves 23; 25 disposed on an outer-concentric length of tubing 22. A first valve 23 is radially disposed opposite with respect to a second valve 25 for promoting an even distribution of circulating fluid throughout the cavity. As illustrated above, the cavity is formed between a first inner-concentric length of tubing and a second outer-concentric length of tubing having a hermetic seal at one or more ends to form a cavity therebetween. The circulating fluid can be facilitated using a pump and a fluid such as a coolant.

The cool air intake of FIG. 6 includes a proximal end 24, and a distal end 21 connected to a filter 26. The cool air intake extends outwardly from the engine to access cool air, filter cool air through the filter to isolate and trap particulate from the input air flow, and distribute a stream of cool air flow into the engine. As the cool air travels toward the engine, at least part of the length of tubing is thermally insulated as described above, therefore heat from the engine compartment is not transferred to the input air flow by way of thermal conduction or heat transfer from the tubing itself. The cool-air intake is therefore adapted to provide cool air to an engine combustion input, earning the title of “cool air intake”.

FIG. 7 is an alternative view of the cool air intake disclosed in FIG. 6. Again, two valves can be used for any of vacuum extraction of air from the cavity, configuration of a thermally insulative material such as silica aerogel, or circulating a fluid through the cavity such as a coolant.

In contrast to the prior art, the embodiments of FIGS. 1-3 and 5-7 include an isolated length of tube for thermally insulated delivery of cool air into the engine combustion input. Accordingly, a cool air intake is provided for increasing fuel efficiency and performance of an automobile engine.

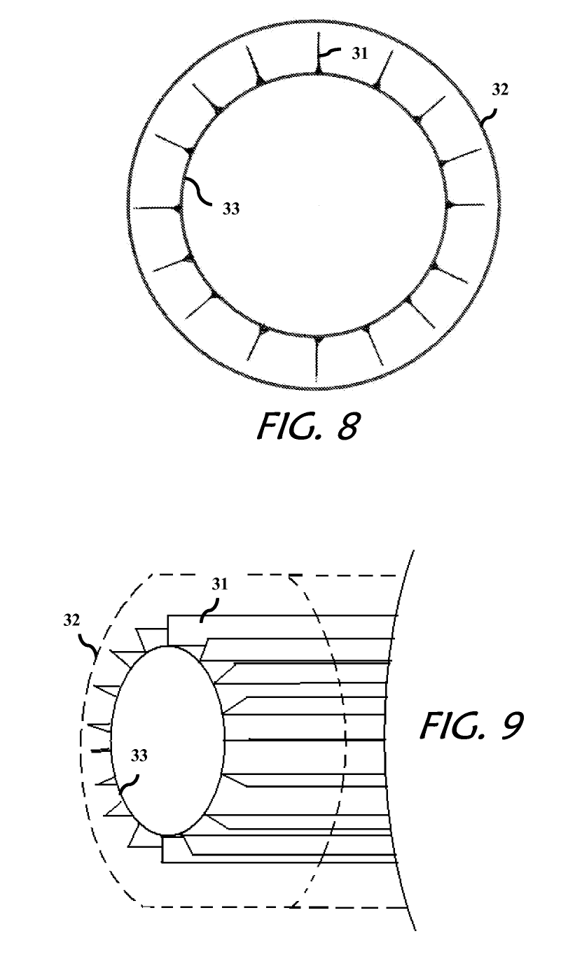

Referring now to FIG. 8, a cross section of the cool air intake is illustrated according to one embodiment of the invention. The cool air intake includes an outer concentric tubing 32 disposed concentrically outside of an inner concentric tubing 33. The inner concentric tubing includes a plurality of surface area fins 31 extending radially outwardly therefrom. The fins and effectively provide an increased surface area for dissipating heat within the cooled region between the first and second concentric tubings. In this embodiment, the inner concentric tubing is effectively isolated from engine compartment heat, and is cool relative to the outer concentric length of tubing. By providing a cool channel for air to flow as it propagates toward the engine intake port, increased horsepower and efficiency of combustion is achieved.

In another embodiment, the inner concentric tubing can include a mesh, such as a square mesh, circular mesh, triangular mesh, honeycomb, or the like (not shown). The mesh can be adapted such that minimal friction or turbulence is introduced to the input air flow. The mesh can provide increased surface area for cooling the input air as it propagates toward the engine intake port.

FIG. 9 further illustrates a perspective cross sectional view of the cool air intake according to the embodiment of FIG. 8. The fins 31 are adapted to extend along up to the entire length of the inner concentric tubing. The fins can be fabricated from aluminum or other thermally conductive material.

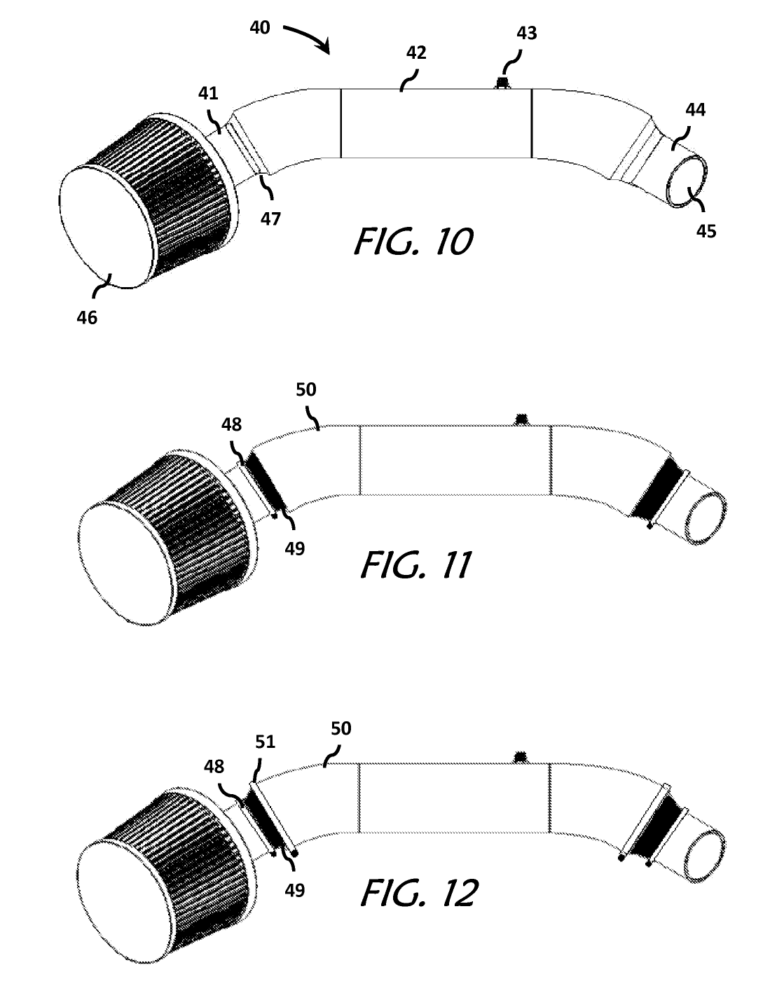

FIGS. 10-12 illustrate various embodiments of the cool air intake. It is important to note that the cooled region can extend up to the entire length of the cool air intake, and that it is preferred to implement a cooled region along substantially most of the length of the cool air intake.

FIG. 10 provides an air intake 40 including an out concentric tubing 42 having at least one valve 43. The outer concentric tubing 42 is concentrically disposed about an inner concentric tubing 44. The outer concentric tubing 42 extends along a substantial length of the inner concentric tubing 44. The inner concentric tubing has an inner surface 45 for contacting and thermally cooling input air flow. The outer concentric tubing is welded to the inner concentric tubing to form a weld fillet 47. The air intake further includes a neck portion 41 for attaching an air filter 46. In this illustration, the cool air intake includes a cooled region disposed along a substantial length of the cool air intake. The cooled region can be configured to extend along a portion, or up to the entire length of the cool air intake.

In another embodiment as illustrated by FIG. 11, a cool air intake can include an outer concentric tubing having a flexible extension 49 connected at a proximal and distal end of the outer concentric tubing. The flexible extension 49 can be frictionally fitted to an inner concentric tubing or securely attached using an adhesive or clamp, such as a hose clamp or T-bolt clamp. In this embodiment, the outer concentric tubing and inner concentric tubing form a cooled region disposed therebetween, the flexible extension hermetically seals the cooled region to provide for vacuum or coolant flow within the cooled region. The hose clamp can be a standard screw-driven hose clamp, or similar hose clamp known in the art.

In yet another embodiment as illustrated in FIG. 12, a cool air intake includes an outer concentric tubing disposed concentrically about an inner concentric tubing, the outer concentric tubing spaced apart and sealed at a proximal end and distal end by a gasket or coupler. The coupler can be made of any material, and preferably a flexible material for permitting a tight seal between the outer and inner concentric tubings. The coupler can be attached to each concentric tubing by an adhesive or clamp, such as a hose clamp.

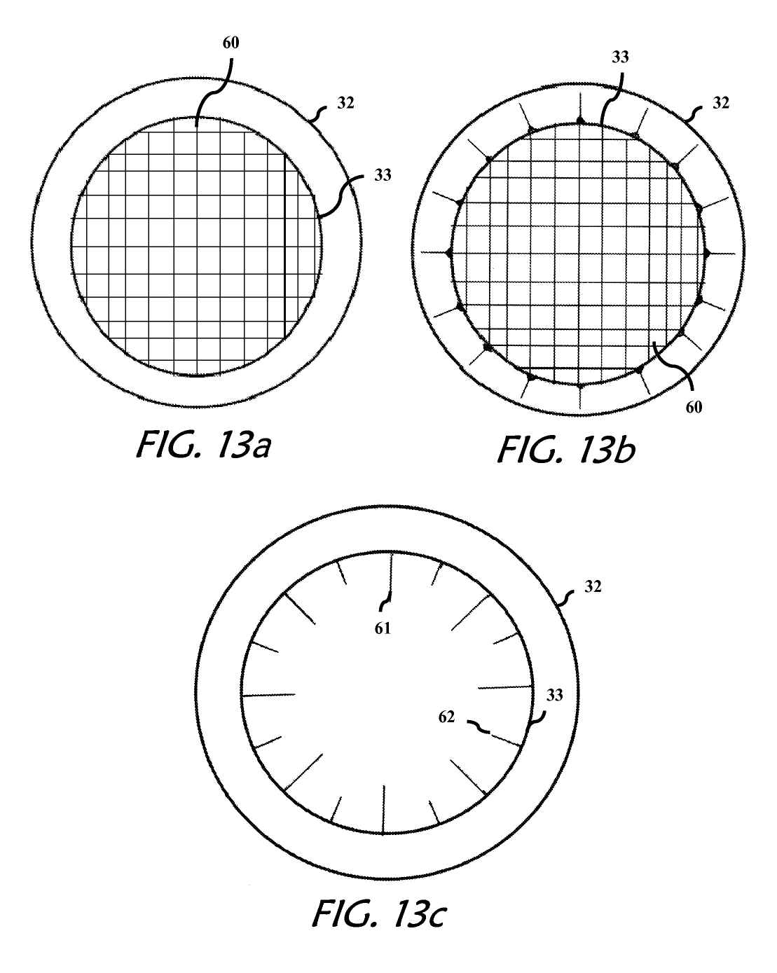

FIG. 13a provides an example of a cool air intake wherein a mesh is located within the inner concentric tubing such that intake air can be cooled along the length of the cool air intake as the air travels toward the engine air intake port. In another embodiment, the cool air intake includes a mesh portion located within the inner concentric tubing, and a plurality of fins extending outwardly from the inner concentric tubing into the cooled region of the cool air intake. The fins can be of uniform size; alternatively the fins can vary in size and thickness. Additionally, various mesh configurations can be implemented such as honeycomb, triangle, square, circular, octagonal, and other mesh configurations. FIG. 13c further illustrates another embodiment of a cool air intake according to the invention, wherein a plurality of fins extend radially inward from the inner concentric tubing such that inbound air can be cooled by the additional surface area of the fins. The fins can vary in length and thickness or can be uniform. Ideally, a large surface area should be provided for optimal cooling of inbound air.

Other combinations or modifications can be implemented by one having skill in the art, such that a cool air intake can be fabricated having an outer concentric tubing, an inner concentric tubing, and a cooled region disposed therebetween.

The above examples are set forth for illustrative purposes and are not intended to limit the spirit and scope of the invention. One having skill in the art will recognize that deviations from the aforementioned examples can be created which substantially perform the same functions and obtain similar results.

I claim:

1. An air intake for a combustion engine, comprising:
a first length of tubing having a first diameter and extending from a proximal end to a distal end;
a second length of tubing having a second diameter larger than said first diameter and being concentrically disposed at least partially along said first length of tubing; and
an air filter attached at said distal end;
wherein said second length of tubing is hermetically sealed at one or more ends to form a cavity between said first and second lengths of tubing.

2. The air intake of claim 1, wherein said second length of tubing is hermetically sealed at two ends to form a cavity between said first and second length of tubing.

3. The air intake of claim 1, wherein said at least one hermetically sealed end includes a welded fillet.

4. The air intake of claim 1, wherein said at least one hermetically sealed end includes a flexible gasket.

5. The air intake of claim 1, wherein said cavity at least partially contains a thermal insulator.

6. The air intake of claim 5, wherein said thermal insulator comprises a silica aerogel.

7. The air intake of claim 1, further comprising at least one valve disposed on said second length of tubing such that said valve is recessed into said cavity.

8. The air intake of claim 7, wherein air is removed at said valve to form a vacuum cavity.

9. The air intake of claim 7, further comprising two valves disposed on said second length of tubing.

10. The air intake of claim 9, wherein said first and second valves are connected to a pump for circulating a fluid throughout said cavity.

11. The air intake of claim 10, wherein said second valve is radially disposed opposite of said first valve for providing an evenly distribution of circulated fluid.

12. The air intake of claim 1, wherein said air filter includes one or more shielded members for isolating the filter from engine compartment heat.

13. An air intake for a combustion engine, comprising:
a first tube having a proximal end and a distal end;
a second tube concentrically disposed about a length of said first tube and being sealed with said first tube at opposing ends to form a cavity between said first and second tubes; and
a filter connected to said distal end of said first tube;
wherein said second tube substantially surrounds said first tube.

14. The air intake of claim 13, further comprising one or more valves attached to said second tube.

15. The air intake of claim 14, wherein said cavity comprises a vacuum region.

16. The air intake of claim 14, wherein said cavity comprises a thermal insulator.

17. The air intake of claim 14, wherein said cavity comprises a circulating fluid.

18. A method of providing cool air to a combustion chamber, comprising;
providing a first tubing adapted to extend outwardly from an engine block and comprising a filter attached to said first tubing at a distal end;
attaching a second tubing concentrically disposed outside of said first tubing at least partially along a length of said first tubing;
hermetically sealing said second tubing to said first tubing to form a cavity between said first and second tubings; and
configuring a volume of said cavity to include a thermal insulator.

19. The method of claim 18, wherein said thermal insulator is one of: vacuum, silica aerogel, or a circulating fluid.
